(19) United States
(12) Patent Application Publication
(10) Pub. No.: US 2006/0288427 A1
(43) Pub. Date: Dec. 21, 2006

(54) Electronic paper and security system

(75) Inventors: Mario Fuse, Kanagawa (JP); Shoji Yamaguchi, Kanagawa (JP); Kunihiro Takahashi, Kanagawa (JP); Yasunori Koda, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/251,919

(22) Filed: Oct. 18, 2005

(30) Foreign Application Priority Data
Jun. 20, 2005 (JP) JP 2005-179077

(51) Int. Cl. H04L 9/32

(52) U.S. Cl. 726/30

(57) ABSTRACT

An electronic paper includes: a main body that is provided with a display unit that displays an image; a storage unit that stores the image data; a controller that controls the display unit to display the image data stored in the storage unit; a battery that supplies electric power to the display unit and the controller; and an cartridge unit that is detachable from the main body and causes the image to be erased from the main body when detached from the main body.

### BACKGROUND OF THE INVENTION

1. Field of the Invention

The present invention relates to an electronic paper and a security system that are improved in security.

2. Description of the Related Art

Electronic papers have a probability that they will spread widely as a tool for assisting intellectual collaboration work done in a prescribed area. The term “prescribed area” means a space (reading place) in which electronic papers are distributed to individuals who join collaboration work and the collaboration work is done on the basis of information displayed thereon, and which the individuals who joined collaboration work exit after its end (the electronic papers are collected).

Secret information may be displayed on the electronic papers, and hence the displayed information should be erased when the individuals exit the prescribed area. Further, since electronic papers are still expensive as a display device, the current situation is such that taking out each electronic paper from the above space is restricted.

For example, a conventional security system that is intended to prevent leakage of information displayed on electronic papers and taking-out of electronic papers employs a method in which each electronic paper is provided with a communication device and the display on each electronic paper is erased when it comes to be unable to receive particular radio waves that are emitted from a prescribed area where a transmission source of the particular radio waves is installed (refer to JP-A-2004-037829).

However, in the conventional security system, each electronic paper needs to be provided with the communication device and the transmission source of the particular radio waves needs to be installed in the prescribed area, which is costly. Further, the carrying-out of an electronic paper itself cannot be prevented. Still further, since information to be displayed is delivered to electronic papers by radio, the information may be radio-intercepted outside the prescribed area or may be radio-intercepted inside the prescribed area and recorded in another recording medium. As such, the use of radio waves is, in itself, a source of security-related problems.

### SUMMARY OF THE INVENTION

According to an aspect of the invention, there is provided an electronic paper including: a main body that is provided with a display unit that displays an image; a storage unit that stores the image data; a controller that controls the display unit to display the image data stored in the storage unit; a battery that supplies electric power to the display unit and the controller; and a cartridge unit that is detachable from the main body and causes the image to be erased from the main body when detached from the main body.

### BRIEF DESCRIPTION OF THE DRAWINGS

In the accompanying drawings:

FIG. 1 is a perspective view of an electronic paper according to a first embodiment;

FIGS. 2A and 2B show a cartridge according to the first embodiment of the invention, wherein FIG. 2A is a plan view and FIG. 2B shows a storage area of a memory unit;

FIG. 3 shows an exemplary security system using the electronic paper according to the first embodiment;

FIG. 4 is a block diagram of a control system of the security system of FIG. 3;

FIG. 5A shows an electronic paper according to a second embodiment of the invention, and FIG. 5B is a sectional view taken along line Vb-Vb in FIG. 5A;

FIG. 6 shows an electronic paper according to a third embodiment; and

FIG. 7 shows an electronic paper according to a fourth embodiment.

### DETAILED DESCRIPTION OF THE INVENTION

Embodiments of the invention are described in detail hereinunder optionally with reference to the drawings attached hereto. In the following description, the same reference is given to the same or the corresponding part, and an overlapping description for it is omitted.

### First Embodiment

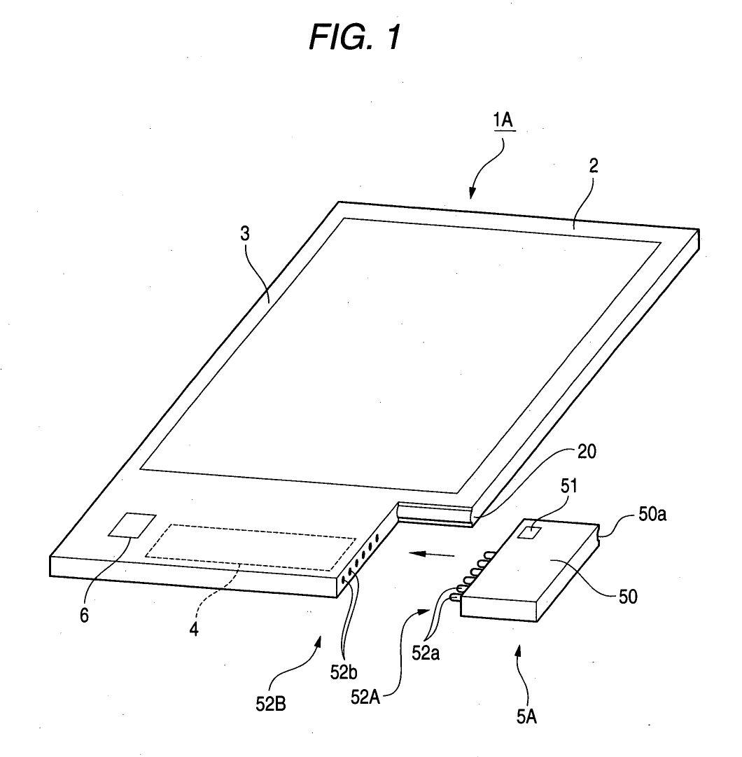

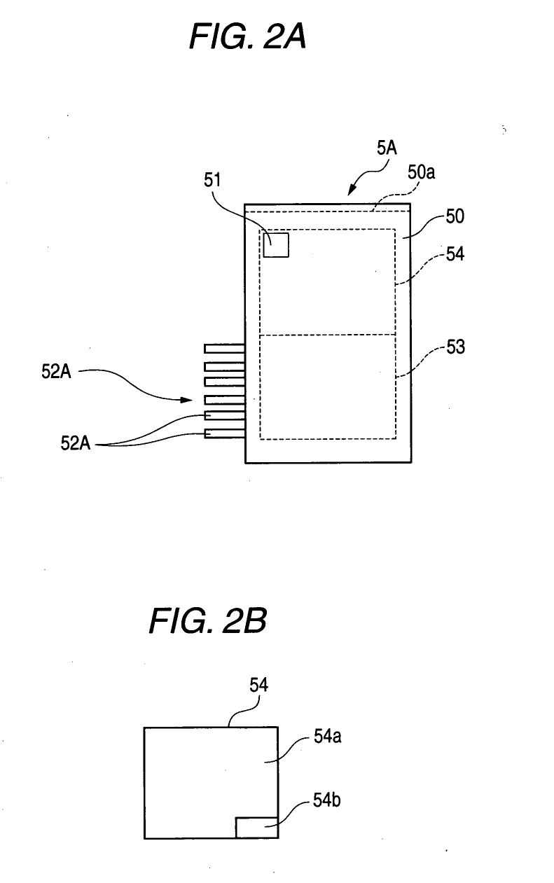

FIG. 1 is a perspective view of an electronic paper according to a first embodiment. FIGS. 2A and 2B show a cartridge, wherein FIG. 2A is a plan view and FIG. 2B shows a storage area of a memory unit. As shown in FIG. 1, the electronic paper 1A is provided with a thin, rectangular main unit 2 and a cartridge 5A as a cartridge unit that is attached to and detached from the main unit 2.

As shown in FIG. 1, the main unit 2 is equipped with a display unit 3 for displaying an image, a page-down key 6, and a controller 4 for reading image data from a memory unit (described later) and causing the image data to be displayed on the display unit 3 and for paging down images to be displayed on the display unit 3 according to a manipulation on the page-down key 6.

It is preferable that the display unit 3 is able to be driven by a detachable thin-film power source and the display disappears instantaneously or in a short time (several seconds to a little more than 10 seconds) after the detachment of the power source. For example, the display unit 3 may, have a general configuration as described in JP-A-2002-22918 in which a bi-stable “contrast medium” such as an electrochromic material, an electroluminescence material, or a liquid crystal material is driven by an electronically addressable driving circuit. Alternatively, as described in JP-A-2004-037829, the display unit 3 may be of an electrophoresis type, a twist ball type, a type in which the degree of absorption of a dye is varied by applying a voltage to a guest-host liquid crystal, or a type composed of a cholesteric liquid crystal and an organic photosensitive material composite film. However, the display unit 3 is not limited to those examples because the storage time of a display can be controlled from a long time to a short time by, for example, properly doing material designing, selecting a device structure, or selecting a driving method.

As shown in FIG. 1, the cartridge 5A is equipped with a thin, rectangular case 50 which as approximately as thick as the main unit 2, a guide groove 50a to be fitted with a guide projection 20 of the main unit 2, a wireless IC tag 51 that is provided on the surface of the case 50, and a male connector 52A for electrically connecting a power source unit 53 and a memory unit 54 (see FIG. 2A) to the controller 4.

The main unit 2 is equipped with a female connector 52B having plural female terminals 52b. The male connector 52A has plural male terminals 52a to be electrically connected to the plural female terminals 52b of the female connector 52B, respectively. The size, shape, position, etc. of the cartridge 5A are not limited to those shown in FIGS. 1, 2A and 2B.

The power source unit 53, which serves to supply electric power for driving of the display unit 3 and the controller 4, may be, for example, a “FLEXIBLE THIN LAYER OPEN ELECTROCHEMICAL CELL” as disclosed in JP-A-2003-297374 (U.S. Pat. No. 5,652,043). This battery can be made as thin as 1 mm or less and can provide sufficient energy for driving of a display device that is used for a meeting of several hours. Therefore, when attached to the main unit 2, the battery fits the main body 2 without causing an incongruous feeling and can supply power without causing any problems relating to the use of the electronic paper 1A.

As shown in FIG. 2B, the memory unit 54 is provided with an image data area to which image data are to be written and an ID area 54b to which identification information (ID) of the electronic paper 1A is to be written.

To prevent damaging of the power source unit 53, the memory unit 54, the male connector 54A, and other portions by reducing impact that occurs when the cartridge 5A is input through an insertion slot of an exit gate section (described later), it is preferable that the cartridge 5A is provided with a protective layer.

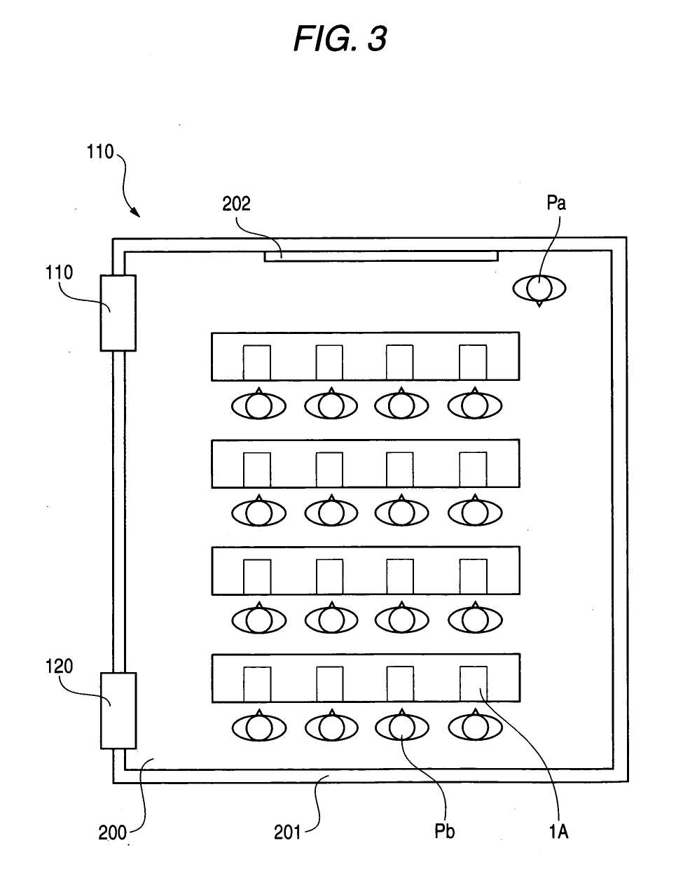

FIG. 3 shows an exemplary security system using the electronic paper 1A shown in FIGS. 1, 2A and 2B. A use space (prescribed area) 200 where the use of the electronic paper 1A is permitted is defined by walls 201, and a presentation display 202 is disposed at the front position of the use space 200.

In the security system 100, an entrance gate section 110 and an exit gate section 120 are provided at an entrance and an exit of the use space 200, respectively.

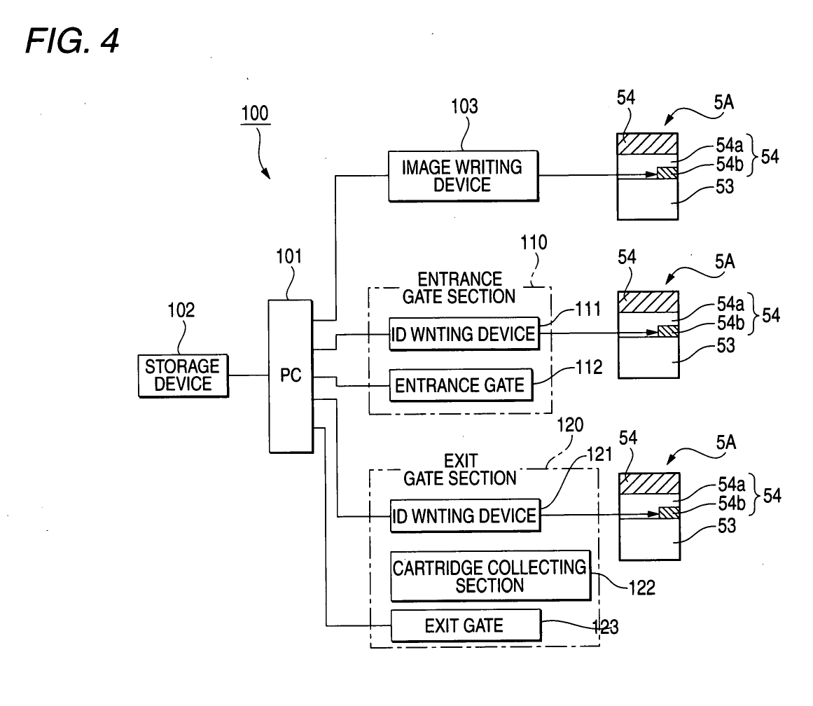

FIG. 4 shows a control system of the security system 100. The security system 100 has a personal computer (PC) 101 for controlling the entire system 100. A storage device 102, an image writing device 103, an ID writing device 111, an entrance gate 112, an ID reading device 121, a cartridge collecting section 122, and an exit gate 123 are connected to the PC 101. The ID writing device 111 and the entrance gate 112 are installed in the entrance gate section 110, and the ID reading device 121, the cartridge collecting section 122, and the exit gate 123 are installed in the exit gate section 120.

The PC 101 is equipped with input devices such as a keyboard and a mouse, a display such as a liquid crystal display, a CPU for controlling the entire system 100, and storage units such as a ROM and a RAM.

Image data to be displayed on the display unit 3 of each electronic paper 1A and an ID list in which IDs of electronic papers 1A are registered are stored in the storage device 102. Pieces of personal information such as names, company names, etc. of users of the electronic papers 1A are registered in the ID list so as to correspond to the respective IDs. The storage device 102 maybe a hard disk drive, for example.

The image-writing device 103 is configured so as to write, via the male connector 52A, image data of plural pages transmitted from the PC 101 to the image data area 54a of the memory unit 54 of the cartridge 5A that is pulled out of each electronic paper 1A. Further, the image-writing device 103 is configured so as to perform a power check on the power source unit 53 in writing image data to the memory unit 54 and, in the event of insufficient charging, turn on a lamp to indicate it. Image data may be written by a different method. For example, image data may be written directly to the memory unit 54 by pulling out the memory unit 54 from the cartridge 5A and connecting it to the image-writing device 103. Alternatively, image data may be written to the memory unit 54 via the wireless IC tag 51.

The ID writing device 111 is configured so as to write an ID transmitted from the PC 101 to the ID area 54b of the memory unit 54 via the wireless IC tag 51 in a state that the cartridge 5A is attached to the main unit 2. An ID may be written by a different method. For example, an ID may be written to the ID area 54b of the memory unit 54 via the male connector 52A after pulling out the cartridge 5A from the main unit 2. Alternatively, an ID may be written directly to the memory unit 54 by pulling out the memory unit 54 from the cartridge 5A and connecting it to the ID writing device 111.

The cartridge collecting section 122 is provided with an insertion slot (not shown) through which cartridges 5A are input and a collection box (not shown) for collecting cartridges 5A that have been input through the insertion slot.

The ID reading device 121 is configured so as to read, via the wireless IC tags 51, IDs from the ID areas 54b of the memory units 54b of cartridges 5A that have been input to the cartridge collecting section 122 through the insertion slot.

Next, the operation of the security system 100 using the electronic paper 1A according to the first embodiment will be described.

(1) Writing of Image

First, an organizer of a presentation writes image data to cartridges 5A that are the same in number as attendees. That is, the organizer manipulates the input devices of the PC 101 to cause image data read from the storage device 102 to be displayed on the display of the PC 101. Then, organizer manipulates the input devices to select image data of plural pages to be written to each memory unit 54. The CPU of the PC 101 transmits the selected image data to the image-writing device 103.

The image-writing device 103 writes, via the male connector 52A, the image data of the plural pages transmitted from the PC 101 to the image data area 54a of the memory unit 54 of the cartridge 5A that is pulled out of each electronic paper 1A. Further, the image-writing device 103 performs a power check on the power source nit 53 and, in the event of insufficient charging, turns on the lamp to indicate it. In the case of insufficient charging, image-writing device 103 recharges the power source unit 53. Alternatively, the power source unit 53 may be replaced by a charged-up one. This eliminates a probability that an electronic paper 1A is rendered unusable due to power-down during its use.

(2) Writing of ID

In the entrance gate section 110, the ID writing device 111 writes an ID to an electronic paper 1A and hands over it to each attendee. More specifically, the organizer manipulates the input devices of the PC 101 to cause an ID list read from the storage device 102 to be displayed on the display of the PC 101. Then, the organizer manipulates the input devices to select an ID to be written to the memory unit 54. The CPU of the PC 101 transmits the selected ID to the ID writing device 111. The ID writing device 111 writes the ID transmitted from the PC 101 to the ID area 54b of the memory unit 54 via the wireless IC tag 51, and transmits an ID writing completion signal to the PC 101. Upon receiving the ID writing completion signal from the ID writing device 111, the PC 101 opens the entrance gate 112. The organizer attaches the ID-written cartridge 5A to the main unit 2 and hands over the electronic paper 1A to an attendee Pb. The attendee Pb passes through the entrance gate 112 bringing the electronic paper 1A, enters the electronic paper use space 200, and sits down. Each main unit 2 may be handed over to an attendee either inside or outside the use space 200.

(3) Presentation

A presenter Pa faces attendees Pb and gives a presentation to the attendees Pb while displaying images of a presentation materials etc. on the presentation display 202. Having an electronic paper 1A, each attendee Pb manipulates the page-down key 6 of the electronic paper 1A to cause the controller 4 to switch the display of the display unit 3 according to the progress of the presentation. Each attendee joins a discussion or the like on the basis of the information displayed on the electronic paper 1A and the presentation display 202.

The information to be displayed on the electronic paper 1A and that to be displayed on the presentation display 202 need not always be identical. This allows the presenter Pa to separately use information to be used for the presentation by himself or herself and information to be presented to the attendees Pb to allow them to be involved in the meeting. For example, to check the degree of understanding of a lecture given by the presenter Pa, the information to be displayed on the presentation display 202 and that to be displayed on the electronic papers 1A may be the contents of the lecture and problems of a check test, respectively.

(4) Collection of Cartridges and Reading of IDs

After completion of the presentation, the organizer requests each attendee Pb to pull out the cartridge 5A from the main unit 2. When the cartridge 5A is pulled out of the main unit 2, the display unit 3 no longer receives power and hence the display on the display unit 3 disappears.

Each attendee leaves his or her seat with the main unit 2 left on the desk and inputs the cartridge 5A to the cartridge collecting section 122 installed in the exit gate section 120 through the insertion slot (not shown). The ID reading device 121 reads, via the wireless IC tag 51, the ID from the ID area 54b of the cartridge 5A that has been input through the insertion slot, and transmits the ID to the PC 101.

The CPU of the PC 101 judges whether the ID transmitted from the ID reading device 121 coincides with one of the IDs in the ID list that is stored in the storage device 102. If ID coincidence is found, the PC opens the exit gate 123. The attendee 123 exits through the exit gate 123. The cartridge 5A is put into the collection box (not shown) of the cartridge collecting section 122.

If the read-out ID is not found in the ID list or the ID cannot be read, the exit gate 123 is not opened and the cartridge 5A is ejected through an ejection slot.

### Advantages of First Embodiment

The first embodiment provides the following advantages:

(a) When the cartridge 5A is removed from the main unit 2, power is no longer supplied to the controller 4 and the display unit 3 is rendered incapable of display. Further, the cartridge 5A having the memory unit 54 is subjected to collection. Therefore, secret information on the electronic paper 1A can be prevented from being taken out.

(b) Each attendee cannot exit without detaching the cartridge 5A from the main unit 2, which prevents taking-out of the electronic paper 1A.

(c) Display on each electronic paper 1A is performed via a signal line on the basis of image data stored in the memory unit 54 of the electronic paper 1A, which makes the probability of data tapping in or in the vicinity of the use space 200 lower than in the conventional case of data delivery by radio and hence enables realization of high security.

(d) Each electronic paper 1A is of a stand-along type and hence its display is not linked with the display of the presentation display 202. And part of or a summarized version of the information used by the presenter Pa for the presentation is displayed on each electronic paper 1A. Therefore, the number of pages to be displayed on each electronic paper 1A is reduced and hence the memory capacity of the memory unit 54 and the load of the power source unit 53 can be reduced.

(e) The information to be displayed on each electronic paper 1A is written to the memory unit 54 in advance, which makes it possible to supply a minimum necessary amount of secret data to each attendee.

To increase the security, the cartridge 5A may be configured so that the image data in the memory unit 54 are erased automatically as soon as the cartridge 5A is removed from the main unit 2. For example, the cartridge 5A may be configured in such a manner that the memory unit 54 employs a volatile memory and the supply of power from the power source unit 53 to the volatile memory is stopped as soon as the cartridge 5A is removed from the main unit 2.

### Second Embodiment

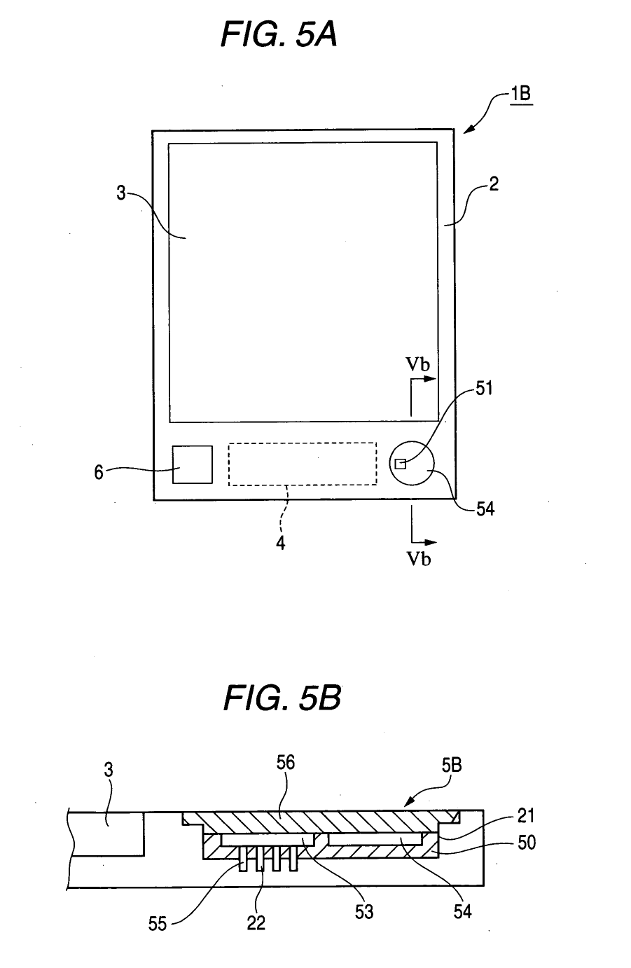

FIG. 5A shows an electronic paper according to a second embodiment of the invention, and FIG. 5B is a sectional view taken along line Vb-Vb in FIG. 5A. This electronic paper 1B is configured in the same manner as the electronic paper 1A according to the first embodiment except for a cartridge 5B. In these figures, an electric connection portion between the cartridge 5B and the main unit 2 is omitted.

The cartridge 5B is equipped with a thin, circular case 50 which is thinner than the main unit 2, a power source unit 53 and a memory unit 54 disposed inside the case 50, plural pins 55 which are led out of the power source unit 53 and the memory unit 54 and are exposed from the bottom surface of the cartridge 5B, and a cap 56 for preventing the case 50 from coming off.

Made of an elastic material such as rubber, the cap 56 fits into the main unit 2 and prevents the case 50 from coming off by its elasticity. An alternative structure is possible in which the cap 56 is made of a resin or a metal and is pressed against the case 50 by a spring member.

The main unit 2 has a fitting recess 21 to be fitted with the case 50 and the cap 56 and connection holes 22 into which the pins 55 of the cartridge 5B are to be inserted. When the pins 55 are connected to the connection holes 21 and the case 50 and the cap 56 are fitted into the fitting recess 21, the power source unit 53 and the memory unit 54 are electrically connected to the display unit 3 and the controller 4 via the pins 55 and the connection holes 22.

According to the second embodiment, as in the case of the first embodiment, leakage of information displayed on the electronic paper 1B and taking-out of the electronic paper 1B can be prevented. Further, having a thin, circular shape, the cartridge 5B can easily be input through the insertion slot of the exit gate section 120.

### Third Embodiment

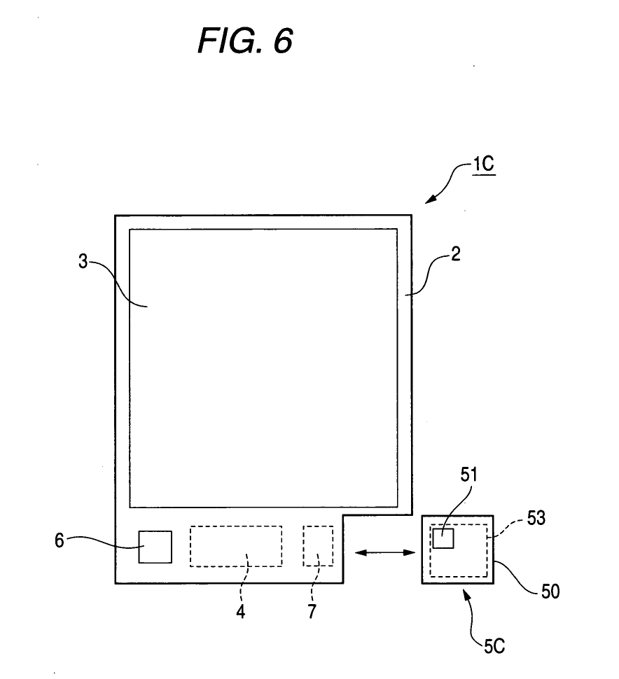

FIG. 6 shows an electronic paper according to a third embodiment of the invention. The third embodiment is the same as the first embodiment except that in the first embodiment the memory unit is moved from the cartridge 5A to the main unit 2. In this figure, an electric connection portion between a cartridge 5C and the main unit 2 is omitted.

It is preferable that a memory unit 7 disposed in the main unit 2 be a volatile memory. With this measure, when the cartridge 5C having the power source unit 53 is removed from the main unit 2, power is no longer supplied to the memory unit 7 and hence the storage content of the memory unit 7 can be erased. Alternatively, the memory unit 7 may be a nonvolatile memory. In this case, an appropriate operation is such that the controller 4 detects removal of the cartridge 5C from the main unit 2 and erases the storage content of the memory unit 7.

In this embodiment, whereas image data are stored in the memory unit 7, an ID is stored in the wireless IC tag 51 by the ID writing device 111.

The third embodiment provides the following advantages:

(a) When the cartridge 5C is removed from the main unit 2, power is no longer supplied to the controller 4 and the display unit 3 is rendered incapable of display. And the storage content of the memory unit 7 disappears because it employs a volatile memory. Therefore, secret information on the electronic paper 1C can be prevented from being taken out.

(b) Each attendee cannot exit without detaching the cartridge 5C from the main unit 2, which prevents taking-out of the electronic paper 1C.

(c) The cartridge 5C is equipped with only the wireless IC tag 51 and the power source unit 53, which makes it possible to reduce the cost of the cartridge 5C.

### Fourth Embodiment

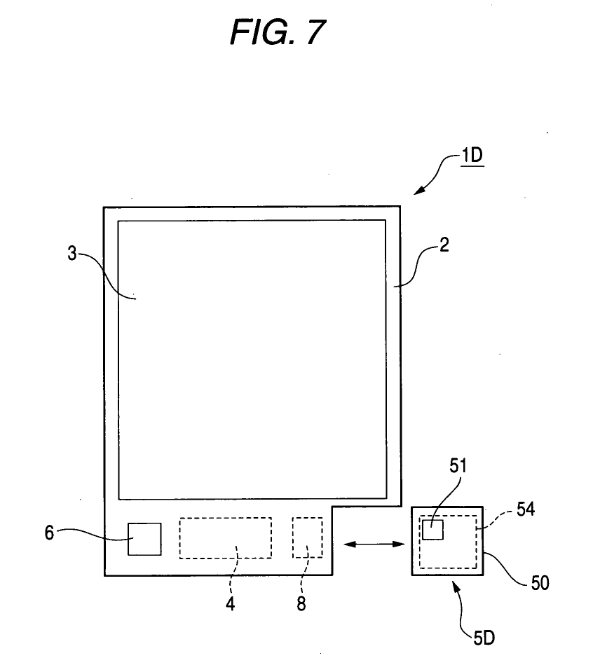

FIG. 7 shows an electronic paper according to a fourth embodiment of the invention. The fourth embodiment is same as the first embodiment except that the power source unit 53 is removed from the cartridge 5A of the first embodiment and a power source unit 58 is provided in the main unit 2. In this figure, an electric connection portion between a cartridge 5D and the main unit 2 is omitted.

The controller 4 of this embodiment is configured so as to erase the display on the display unit 3 upon detecting removal of the cartridge 5D from the main unit 2.

The fourth embodiment provides the following advantages:

(a) When the cartridge 5D is removed from the main unit 2, the controller 4 controls the display unit 3 so as to erase its display. Further, the cartridge 5D having the memory unit 54 is subjected to collection. Therefore, secret information on the electronic paper 1D can be prevented from being taken out.

(b) Each attendee cannot exit without detaching the cartridge 5D from the main unit 2, which prevents taking-out of the electronic paper 1D.

(c) The cartridge 5C is equipped with only the wireless IC tag 51 and the memory unit 54, which makes it possible to reduce the cost of the cartridge 5D.

The invention is not limited to the embodiments described above, and various modifications are possible without departing from the spirit and scope of the invention. The components of the embodiments can be combined with each other arbitrarily without departing from the spirit and scope of the invention.

The entire disclosure of Japanese Patent Application No. 2005-179077 filed on Jun. 20, 2005 including specification, claims, drawings and abstract is incorporated herein by reference in its entirety.

What is claimed is:

1. An electronic paper comprising:
a main body that is provided with a display unit that displays an image;
a storage unit that stores the image data;
a controller that controls the display unit to display the image data stored in the storage unit;
a battery that supplies electric power to the display unit and the controller; and
a cartridge unit that is detachable from the main body and causes the image to be erased from the main body when detached from the main body.

2. The electronic paper according to claim 1, wherein the main body is further provided with the storage unit and the controller,
wherein the cartridge unit is provided with the battery, and
wherein the controller erases the image data from the storage unit when the cartridge unit is detached from the main body.

3. The electronic paper according to claim 1, wherein the main body is further provided with the battery and the controller,
wherein the cartridge unit is provided with the storage unit, and
wherein the controller erases the image displayed on the display unit when the cartridge unit is detached from the main body.

4. The electronic paper according to claim 1, wherein the cartridge unit is provided with the storage unit and the battery.

5. The electronic paper according to claim 3, wherein the controller erases the image data from the storage unit when the cartridge unit is detached from the main body.

6. The electronic paper according to claim 4, wherein the controller erases the image data from the storage unit when the cartridge unit is detached from the main body.

7. The electronic paper according to claim 1, wherein the cartridge unit is provided with a recording unit that stores identification information that is readable with a reading device.

8. The electronic paper according to claim 1, wherein the storage unit stores the image data of images of plural pages, and
wherein the controller pages down the images displayed on the display unit in accordance with a page-down manipulation.

9. A security system comprising:
a detection unit that detects a cartridge unit that is detached from a main body of an electronic paper; and
a gate control unit that monitors passage of a user of the electronic paper when the cartridge unit is detected by the detection unit.

10. The security system according to claim 9, wherein the gate control unit further including a gate which is controlled its open and close, and the gate control unit controls the gate based on the detection by the detection unit.

11. The security system according to claim 9, wherein the detection unit has a insertion slot through which the cartridge unit is inserted.

12. A security system comprising:
a reading unit that reads an identification information from a cartridge unit that is detached from a main body of an electronic paper, wherein the cartridge unit is provided with a recording unit that stores the identification information; and
a gate control unit that receives the identification information read by the reading unit and checks the identification information.
